(19) United States
(12) Patent Application Publication
(10) Pub. No.: US 2003/0232313 A1
(43) Pub. Date: Dec. 18, 2003

(54) Globe surface lights

(76) Inventor: Mark Egerton Paul Coates, Georgetown (CA)

Correspondence Address: MARK E. P. COATES, 13161 22ND. SIDE ROAD, GEORGETOWN, ON, L7G 4S4, CA

(21) Appl. No.: 10/302,638

(22) Filed: Nov. 25, 2002

(30) Foreign Application Priority Data
Jun. 18, 2002 (CA) 2,389,945

(51) Int. Cl. G09B 27/06

(52) U.S. Cl. 434/287

(57) ABSTRACT

The finished product is a globe, which has been modified/remanufactured to house a light source in the interior of the globe.

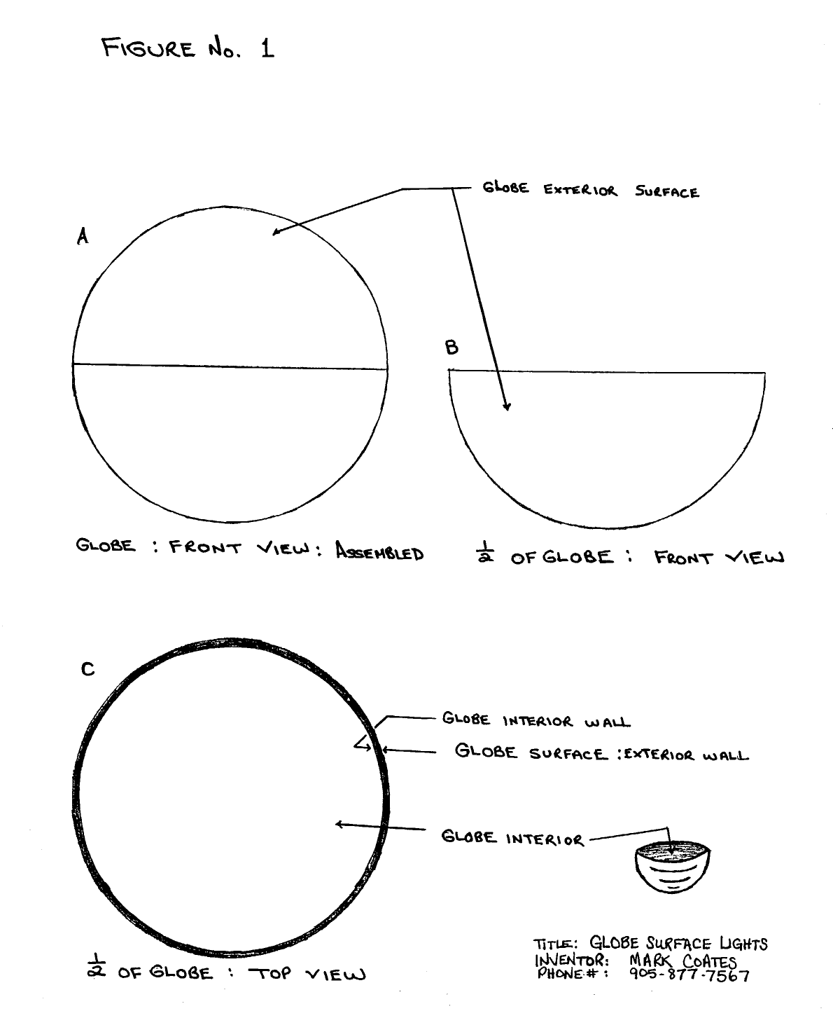

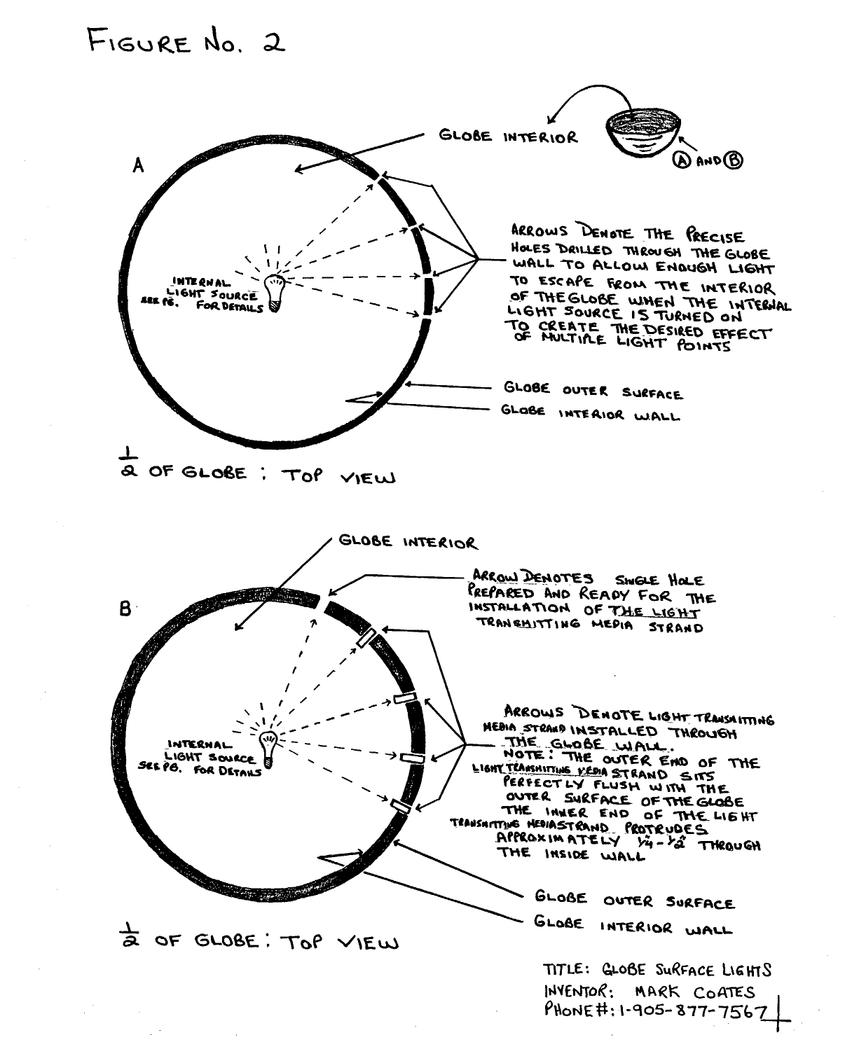

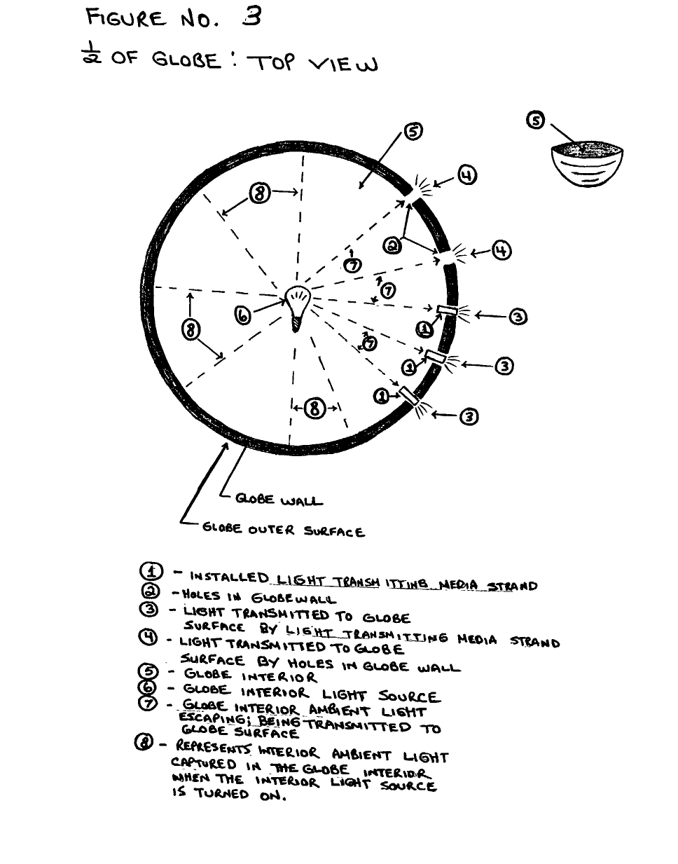

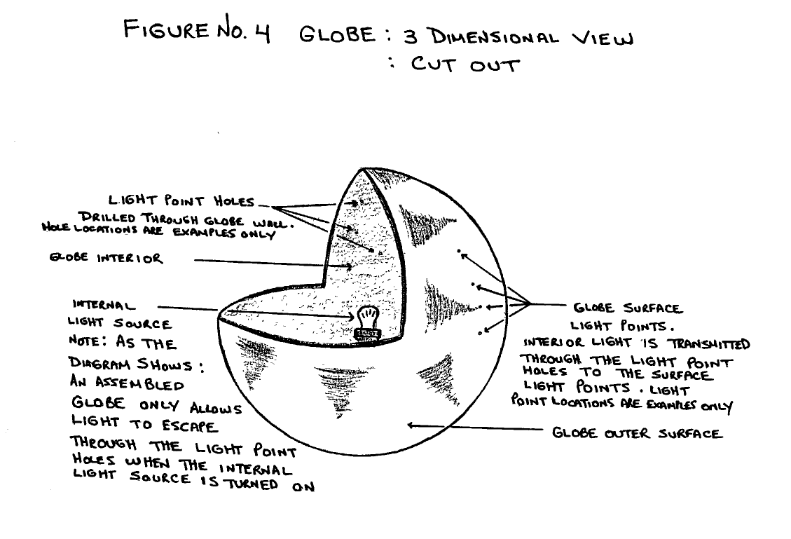

The surface of the globe is remanufactured by drilling precise holes in predetermined locations from the outer surface and through to the inner surface of the globe. These holes permit the interior ambient light created (when the interior light source is turned on) to escape or be transmitted out from the interior of the globe. The interior light escapes via the precise point of the hole on the surface of the globe.

The placement of multiple holes on the surface of the globe allows for multiple precise points of light to escape from the interior of the globe.

An example: if the precise points of light escape from the world's major cities (as depicted on the printed surface/map of the globe), the desired effect would be a view of our:

Earth's night time surface as may be seen from near space;

Earth's night-lights

Earth's population depicted with light

Earth's city and town light output

Earth's electrical output

### CROSS REFERENCE TO RELATED APPLICATIONS

I have filed a prior nonprovisional patent application in Canada titled:

### Globe Surface Lights

File Date: Jun. 18, 2002

Application No.: 2,389,945

See (attached): “Canadian Intellectual Property Office Filing Certificate”

### STATEMENT REGARDING FEDERALLY SPONSORED RESEARCH OR DEVELOPMENT

Not applicable

### REFERENCE TO SEQUENCE LISTING, A TABLE OR A COMPUTER PROGRAM LISTING COMPACT DISC APPENDIX

Not applicable

### BACKGROUND AND BRIEF SUMMARY OF THE INVENTION

This invention relates to an “Earth Globe/Planetary Globe/Celestial Globe” or any other hollow sphere which shows specific custom placed precise points of light on the surface of the globe, to give the effect of, i.e.: a view of the Planet Earth in a night or dark sky from space.

Based on patent searches undertaken by Mark Coates and an in depth review of globe manufacturers world wide, I have determined to the best of my understanding that no other globe has been produced and or legally protected by means of a patent; utilizing my manufacturing process and therefore achieving the end result of (my invention):

### Globe Surface Lights

The inventive idea which my process embodies is as follows: To capture and fully control a light source located in the interior of a globe and to direct the light to numerous miniature precise globe surface locations, to give a truly new and unique visual effect to globes. Widely used today, globes have not significantly changed their visual appearance, since the inception of globe manufacturing.

This is a truly unique innovation in the manufacture of globes.

### BRIEF DESCRIPTION OF THE SEVERAL VIEWS OF THE DRAWING

SHEET #1 FIG. #1

(A) Shows a globe assembled

(B) Shows ½ of a disassembled globe—(front view)

(C) Shows ½ of a disassembled globe—(top view) before remanufacture/modification, to simply illustrate the parts that will be remanufactured/modified.

SHEET #2 FIG. #2

(A)(B) The figures show ½ of the globe top view and looking into the interior of the ½ of the globe.

The internal light source is depicted in FIGS. #2(A) and (B) and FIG. #3 as a diagram of a light bulb. The broken lines shown in the globe interior are used to illustrate the ambient light produced inside the globe when the internal light source is turned on. Arrows at the end of the broken lines shown in the interior of the globe indicate the light that is able to escape or be transmitted from the interior of the globe to the outer surface of the globe when the internal light source is turned on.

SHEET #3 FIG. #3

This figure shows the same view as FIGS. #2(A) and (B), with the addition of an illustration of the interior ambient light being transmitted from the interior of the globe to the outer surface of the globe. Refer to (3) and (4) in FIG. #3

Note: you would not typically utilize both methods of transmitting the ambient light from the interior of the globe to the outer surface of the globe. This figure shows both methods of transmitting the ambient light from the globe interior to the outer surface of the globe simply to illustrate how both methods function. SHEET #4 FIG. #4

This figure shows a three dimensional view with approximately ¼ of the globe cut away to illustrate the light source in the centre of the interior of the globe. This figure illustrates that the interior ambient light escapes/is transmitted though the light holes to the surface of the globe. (See globe surface light points.)

### TECHNICAL DESCRIPTION MANUFACTURING PROCESS

The globe must be in a state of disassembly before my proposed manufacturing process can begin. More precisely, the globe is separated into two halves along the latitudinal centre, see FIGS. #1(A), (B), (C). For example, where a model of the earth is utilized, the globe is separated at the equator leaving two exact halves of the globe, a Northern Hemisphere and a Southern Hemisphere. This allows the manufacturer complete and unobstructed access to the interior of the globe.

Once the exact locations of all the light points on the globe surface have been decided upon, the holes in the globe surface can be drilled (prepared) see FIGS. #2 and #3.

The diameter of the holes placed through the globe wall and surface determine the amount/level of visible light that will escape [be transmitted] from the interior light source (once the globe is reassembled and the interior light source is turned on).

Where the globe wall thickness does not allow an adequate level of visible light to escape/be transmitted from the interior of the globe through the drilled holes (once the globe is reassembled and the interior light source is turned on), then, a single strand of light transmitting media will be inserted into the prepared hole and through the globe wall—see FIG. #2(B) and FIG. #3. This facilitates the transmission of the interior light source to the surface of the globe. When the light transmitting media strand installation is complete, one end of the strand will sit flush with the outer surface of the globe wall and the other end of the strand will protrude through the inside wall approximately ¼ to ½—see FIG. #2(B) and FIG. #3.

Note: the diameters of finished light points vary. They are determined by the diameter/size of hole that is placed through the globe wall. The following hole diameters are identified as examples only. [0.020″] [0.038″]

These hole (openings) diameters and various other comparable hole diameters are used to achieve the desired effect of precise light points on the outer surface of the globe, when the globe is reassembled and the interior light source is turned on.

A Full Description—Use:

People have used celestial globes for many years as art objects (objet d'art), educational tools, business tools, interior designs, ornaments, etc.

There have been some minor developments/enhancements in globes since their inception, however, we have found no process producing effects remotely similar to our “GLOBE SURFACE LIGHTS” either in our searches or in our investigation with globe manufacturers worldwide.

Transmitting precise light points from the interior of the globe to specific points on the surface of the globe is an effective innovation to the globe and no manufacturing process has achieved a similar result—to the best of our knowledge.

Our globe light system can be utilized as follows:

Educational tool

Business tool

Advertising

Conversation Piece

Art Object

Useful tool for integrating transportation, mining and logistics companies—to name just a few.

Interior Design ornaments

Any application where a celestial globe would be advantageous.

Note: All globes can be modified as a custom made request based on customer requirements to highlight for example: geographical locations; cities; towns; head and branch offices; power plants; and/or various international facilities to name a few. Any other multiple of precise light points may be used.

What I claim as my invention is as follows:

1. In the case of an improved product:
(1) A planetary globe, earth globe, celestial globe, etc., which is remanufactured to incorporate/have multiples of miniature, precise, visible points of light emanating from the surface of the globe. The installation and control of a light source inside the interior of the globe. When the light source is turned on; to transmit the ambient light from the interior of the globe to the miniature precise points of light on the outer surface of the globe.
(2) To prepare the walls of the globe to transmit the ambient light from the interior of the globe (when the interior light source is turned on) to the miniature, precise points of light on the surface of the globe by drilling and preparing miniature precise holes through the globe wall.
(3) To install light transmitting media strands in each hole through the globe wall to transmit the interior ambient light to the outer surface of the globe where the globe wall thickness does not allow a simple hole to transmit enough ambient light to escape from the interior of the globe to create the desired effect on the surface of the globe.
